(19) United States
(12) Patent Application Publication
(10) Pub. No.: US 2026/0149091 A1
(43) Pub. Date: May 28, 2026

(54) POUCH FOLDING DEVICE FOR SECONDARY BATTERY

(71) Applicant: CLEVER CO., LTD., Chungcheongbuk-do (KR)

(72) Inventors: Jong Hong JEONG, Chungcheongbuk-do (KR); Sang Jin KIM, Daejeon (KR)

(21) Appl. No.: 18/958,204

(22) Filed: Nov. 25, 2024

(51) Int. Cl. H01M 50/105; B29C 53/04; B29L 31/34

(52) U.S. Cl. CPC H01M 50/105; B29C 53/04; B29L 2031/3468

(57) ABSTRACT

Disclosed is a pouch folding device for a secondary battery, the pouch folding device including a lower prop configured to support a lower surface of a terrace of a pouch-type secondary battery, an upper prop configured to grip the terrace together with the lower prop by pressing an upper surface of the terrace, which is placed on the lower prop, toward the lower prop, and a pusher configured to fold the terrace based on a folding line portion by displacing the terrace in a stepwise manner by applying heat and force while coming into contact with the terrace exposed to the outside of the lower prop and the upper prop.

### FIELD

The present disclosure relates to a pouch folding device for a secondary battery, the pouch folding device being capable of folding a terrace of a pouch-type secondary battery by 180 degrees.

### BACKGROUND

This section provides background information related to the present disclosure which is not necessarily prior art.

In general, as illustrated in FIG. 1, a pouch-type secondary battery 1 (hereinafter, referred to as a “secondary battery”) includes an electrode assembly 2, a pouch casing 3 configured to accommodate the electrode assembly 2 and an electrolyte, and electrode tabs 4 extending and protruding to the outside from the electrode assembly 2.

Further, the pouch casing 3 includes an upper pouch 5 and a lower pouch 6. The upper and lower pouches 5 and 6 define a main chamber M that accommodates the electrode assembly 2 and the electrolyte therein. Edges (hereinafter, referred to as “terraces”) 7 of the upper and lower pouches 5 and 6 are bonded (sealed) to each other.

In this case, typically, the upper and lower pouches 5 and 6 may each be provided in the form of a thin aluminum film to protect the electrolyte and the electrode assembly 2, cope with the electrochemical characteristics of the electrode assembly 2, and ensure heat dissipation performance. To bond the upper and lower pouches 5 and 6, polymers, such as casted polypropylene (CPP) resin or polypropylene (PP) resin, are applied onto the thin aluminum films constituting the upper and lower pouches 5 and 6, and the applied polymers are fused to define bonding layers.

Meanwhile, the terrace 7 formed by bonding the upper pouch 5 and the lower pouch 6 is divided into long side terraces 7a supported on two opposite surfaces of a main chamber M, and short side terraces 7b supported on two opposite ends of the main chamber M.

In this case, as illustrated in FIG. 2, the long side terrace 7a (hereinafter, referred to as a “terrace”) is folded to have multiple steps in order to prevent corrosion from occurring in a bonded region, improve rigidity of the pouch casing 3, and minimize a space occupied by the secondary battery 1 by reducing an overall size.

For example, an operation of folding the terrace 7a is performed by folding an extension end side of a bonded region of the terrace 7a by 180 degrees and then folding a start end side of the bonded region of the terrace 7a by 90 degrees, such that the terrace 7a is folded at 270 degrees.

### SUMMARY

The present disclosure provides a pouch folding device for a secondary battery, the pouch folding device being capable of folding an extension end side of a bonded region of a terrace by 180 degrees by displacing the extension end side of the bonded region of the terrace in a stepwise manner while coming into surface contact with the extension end side of the bonded region of the terrace.

The present disclosure also provides a pouch folding device for a secondary battery, the pouch folding device being capable of allowing a terrace to have a shape folded at 270 degrees by displacing a start end side of a bonded region of the terrace in a stepwise manner while coming into surface contact with an extension end side of the bonded region of the terrace and the start end side of the bonded region of the terrace that are folded at 180 degrees.

The present disclosure also provides a pouch folding device for a secondary battery, wherein the pouch folding device enables a pusher for folding a terrace to continue to heat the terrace by maintaining surface contact with the terrace.

The present disclosure also provides a pouch folding device for a secondary battery, wherein the pouch folding device enables a pusher for directly contacting a folding line portion formed when a terrace folding is performed and heating the folding line portion.

For solving the above-described technical problems, the present disclosure provides a pouch folding device for a secondary battery, the pouch folding device including: a lower prop configured to support a lower surface of a terrace of a pouch-type secondary battery; an upper prop configured to grip the terrace together with the lower prop by pressing an upper surface of the terrace, which is placed on the lower prop, toward the lower prop; and a pusher configured to fold the terrace based on a folding line portion by displacing the terrace in a stepwise manner by applying heat and force while coming into contact with the terrace exposed to the outside of the lower prop and the upper prop.

In the pouch folding device for a secondary battery according to one aspect of the present disclosure, a heater may be embedded in the pusher, the pusher may have a concave groove that surrounds the folding line portion, and the groove may apply heat and force to the folding line portion.

In the pouch folding device for a secondary battery according to one aspect of the present disclosure, the upper prop may include: a flat pressing portion configured to press the upper surface of the terrace toward the lower prop; an edge portion formed at an edge at which one side surface of the upper prop, which faces the pusher, and the pressing portion are connected, the edge portion being configured to form the folding line portion so that the terrace is folded upward by an operation of the pusher; and a seat portion formed on one side surface of the upper prop, which faces the pusher, and inclined upward from the edge portion with respect to the pressing portion in a direction away from the pusher, the seat portion being configured to allow the terrace, which is folded upward, to be further folded by the operation of the pusher.

In the pouch folding device for a secondary battery according to one aspect of the present disclosure, the pusher may include: a flat upper surface configured to come into surface contact with the lower surface of the terrace exposed to the outside of the lower prop and the upper prop; a first forming portion configured to fold the terrace upward based on the edge portion while being raised; a second forming portion configured to attach the terrace, which is folded by the first forming portion, tightly to the seat portion while being moved inclinedly toward the seat portion; and a third forming portion configured to fold the terrace by 180 degrees by pressing the terrace toward the lower prop while being moved upward from the terrace, which is folded by the second forming portion, and raised.

In the pouch folding device for a secondary battery according to one aspect of the present disclosure, the first forming portion may be one side surface facing the lower prop and the upper prop, the first forming portion may be connected to the upper surface and formed perpendicularly to the upper surface, the second forming portion may be formed to be inclined downward from a distal end of the first forming portion in a direction away from the lower prop and the upper prop, the groove may be provided at a distal end of the second forming portion, and the third forming portion may have a flat lower surface positioned below the groove.

In the pouch folding device for a secondary battery according to one aspect of the present disclosure, the upper surface and the first forming portion may be connected smoothly without a sharp corner by means of a first inclined portion formed as an inclined surface.

In the pouch folding device for a secondary battery according to one aspect of the present disclosure, the third forming portion may be connected to a distal end of the groove and have an avoidance portion facing the lower prop and the upper prop, and the avoidance portion and the lower surface may be connected smoothly without a sharp corner by means of a second inclined portion formed as an inclined surface.

In the pouch folding device for a secondary battery according to one aspect of the present disclosure, the avoidance portion may be formed to be retracted from the distal end of the groove in the direction away from the lower prop and the upper prop.

In the pouch folding device for a secondary battery according to one aspect of the present disclosure, the pusher may include: a flat upper surface configured to come into surface contact with the lower surface of the terrace exposed to the outside of the lower prop and the upper prop; a fourth forming portion configured to fold the terrace upward based on the edge portion while being raised; and a fifth forming portion configured to fold the folded terrace by 90 degrees or more by attaching the terrace, which is folded by the fourth forming portion, tightly to the seat portion while being moved inclinedly toward the seat portion.

In the pouch folding device for a secondary battery according to one aspect of the present disclosure, the fourth forming portion may be one side surface facing the lower prop and the upper prop, the fourth forming portion may be connected to the upper surface and formed perpendicularly to the upper surface, the fifth forming portion may be formed to be inclined downward from a distal end of the fourth forming portion in a direction away from the lower prop and the upper prop, and the groove may be positioned at a distal end of the fifth forming portion.

In the pouch folding device for a secondary battery according to one aspect of the present disclosure, the upper surface and the fourth forming portion may be connected smoothly without a sharp corner by means of an inclined portion formed as an inclined surface.

In the pouch folding device for a secondary battery according to one aspect of the present disclosure, the edge portion may further protrude toward the terrace than the lower prop.

According to the present disclosure, the single pusher is used to displace the extension end side of the bonded region of the terrace in a stepwise manner, and the extension end side of the bonded region of the terrace is folded by 180 degrees, such that the configuration of the device is simple, and the maintenance of the device may be facilitated.

According to the present disclosure, the single pusher is used to displace the start end side of the bonded region of the terrace, which has the extension end side of the bonded region folded at 180 degrees, in a stepwise manner, such that the terrace has a shape folded at 270 degrees so that the start end side of the terrace is folded at 90 degrees or more. Therefore, the configuration of the device is simple, and the maintenance of the device may be facilitated.

According to the present disclosure, the pusher continuously heats the terrace by coming into surface contact with the extension end of the bonded region of the terrace, such that the extension end side of the bonded region of the terrace is easily folded.

According to the present disclosure, the folding line portion, which is formed when the extension end side of the bonded region of the terrace is folded, may be heated, such that spring back may be prevented, and forming characteristics may be improved.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view schematically illustrating a pouch-type secondary battery related to the present disclosure;

FIG. 2 is a view schematically illustrating a process of folding a terrace of the pouch-type secondary battery illustrated in FIG. 1; and

FIGS. 3, 4, 5, 6, 7, 8, 9, 10 and 11 are views schematically illustrating one embodiment of a pouch folding device for a secondary battery, i.e., views sequentially illustrating a process of folding a terrace by the pouch folding device for a secondary battery according to the present disclosure.

FIGS. 12, 13, 14, 15 and 16 are views schematically illustrating another embodiment of a pouch folding device for a secondary battery, i.e., views sequentially illustrating a process of folding a terrace by the pouch folding device for a secondary battery according to the present disclosure.

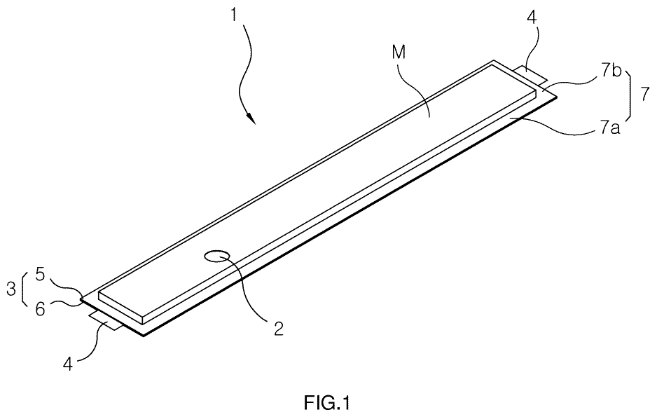

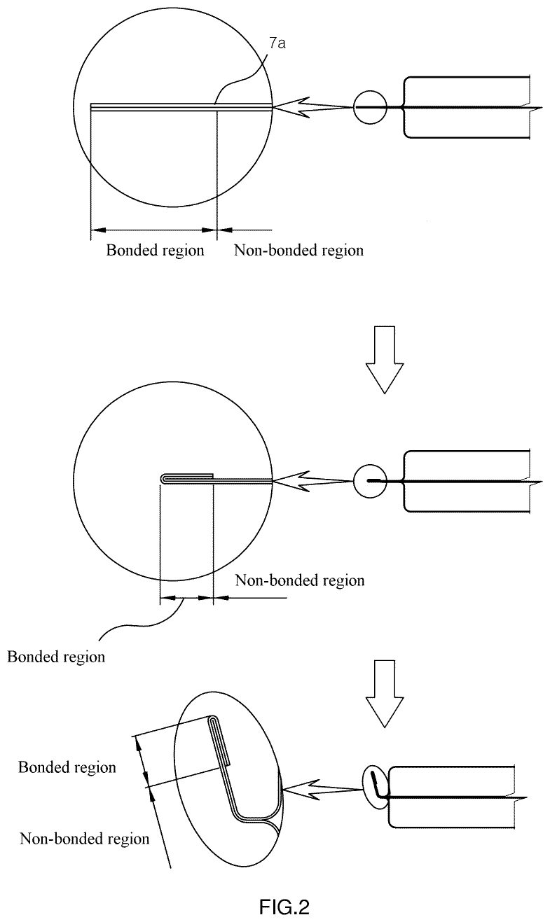

### DETAILED DESCRIPTION

Exemplary embodiments of the present disclosure will now be described in detail with reference to the accompanying drawings.

Hereinafter, exemplary embodiments of a pouch folding device for a secondary battery according to the present disclosure will be described in detail with reference to the drawings.

However, it should be noted that the intrinsic technical spirit of the present disclosure is not limited by the following exemplary embodiment, and the following exemplary embodiment may easily be substituted or altered by those skilled in the art based on the intrinsic technical spirit of the present disclosure.

In addition, the terms used herein are selected for convenience of description and should be appropriately interpreted as a meaning that conform to the technical spirit of the present disclosure without being limited to a dictionary meaning when recognizing the intrinsic technical spirit of the present disclosure.

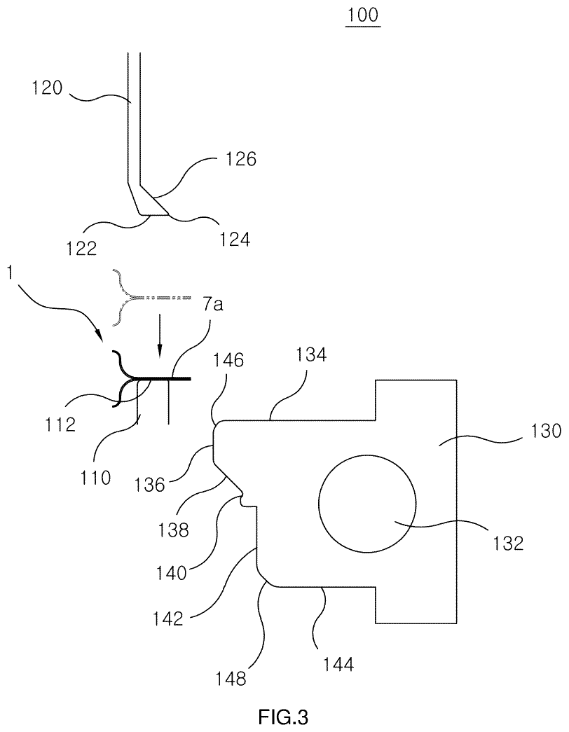

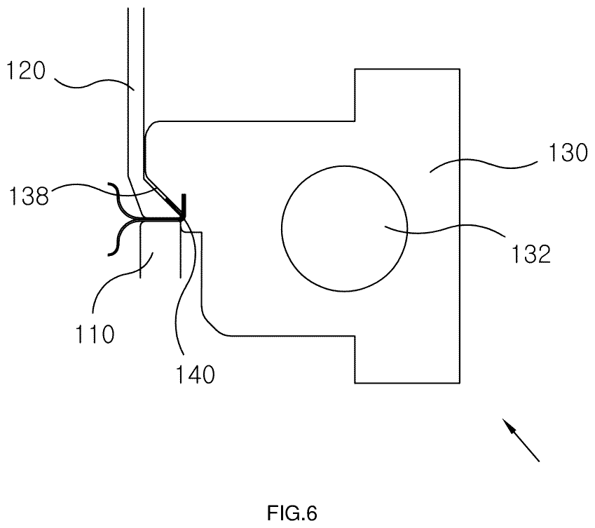

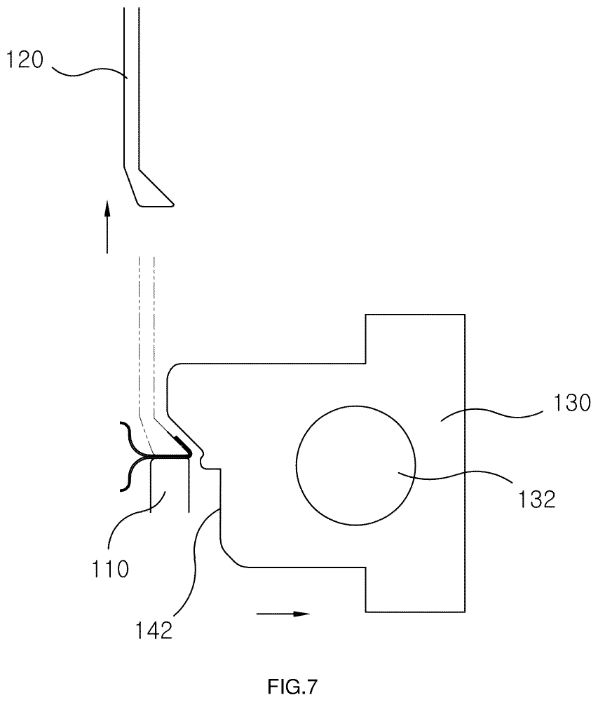

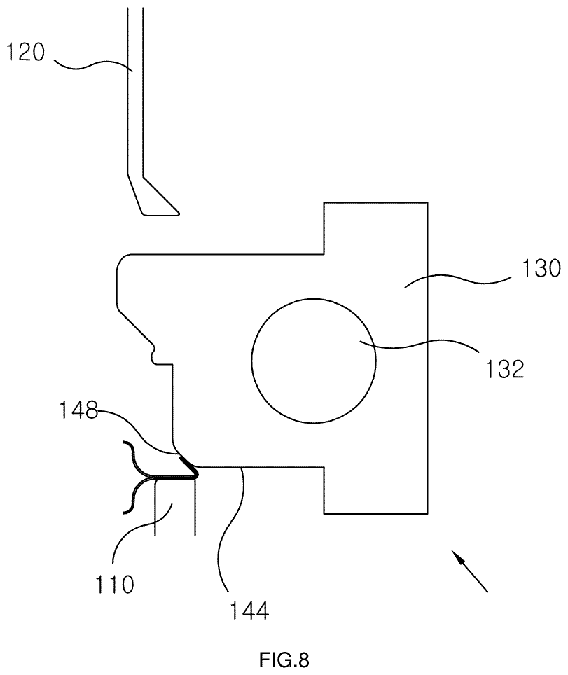

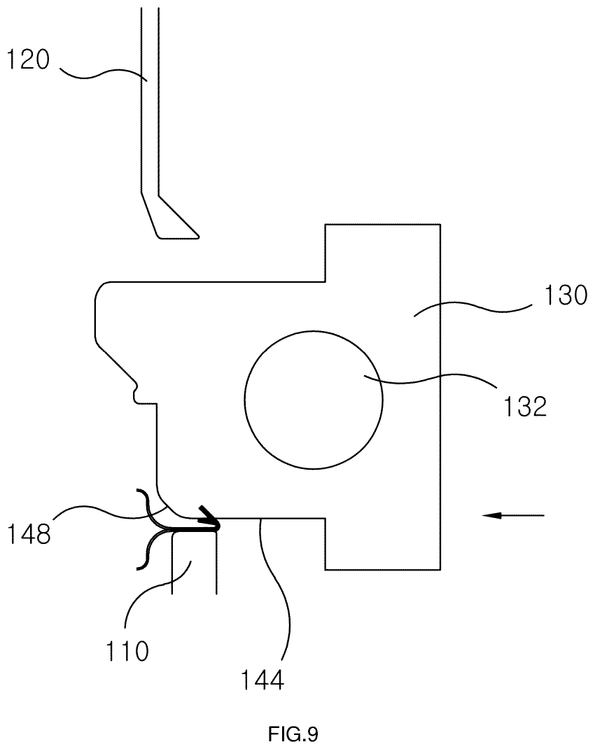

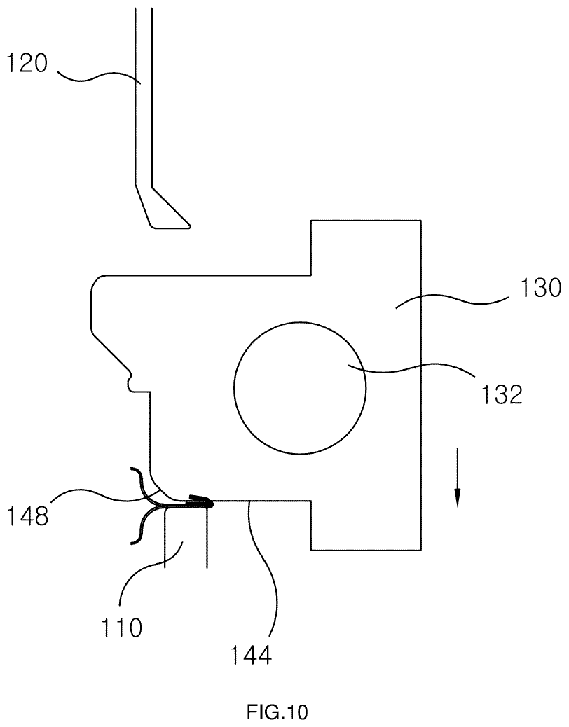

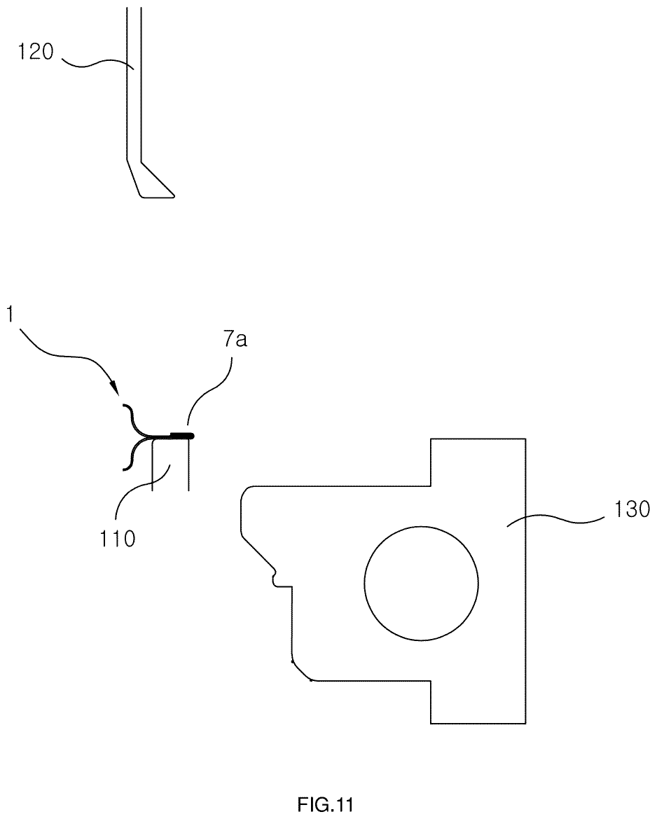

Among the accompanying drawings, FIGS. 3 to 11 are views schematically illustrating one embodiment of a pouch folding device for a secondary battery according to the present disclosure.

With reference to FIGS. 3 to 11, a pouch folding device 100 for a secondary battery according to the present disclosure includes a lower prop 110, an upper prop 120, and a pusher 130.

The lower prop 110 supports a lower surface of a terrace 7a of a pouch-type secondary battery 1 loaded onto and guided by a cell transfer shuttle (not illustrated) during a preceding process.

The lower prop 110 has a length corresponding to a length of the terrace 7a. A flat support portion 112 is formed on an upper surface of the lower prop 110, and the lower surface of the terrace 7a is placed on the flat support portion 112.

When the pouch-type secondary battery 1 is loaded onto and guided by the cell transfer shuttle, the lower surface of the terrace 7a is supported on the support portion 112 of the lower prop 110 by a downward operation of the cell transfer shuttle.

Particularly, the support portion 112 of the lower prop 110 supports the lower surface of the terrace 7a, which faces a middle end side of a bonded region of the terrace 7a, so that an extension end side of the bonded region of the terrace 7a is exposed to the pusher 130. The extension end side of the bonded region of the terrace 7a exposed to the outside of the support portion 112 is folded by an operation of the pusher 130.

The upper prop 120, together with the lower prop 110, grips the terrace 7a by pressing an upper surface of the terrace 7a of the pouch-type secondary battery 1, which is placed on the lower prop 110, toward the lower prop 110.

The upper prop 120 has a length corresponding to the length of the terrace 7a. A flat pressing portion 122 is formed on a lower surface of the upper prop 120 and comes into contact with the upper surface of the terrace 7a to press the upper surface of the terrace 7a toward the lower prop 110.

The pressing portion 122 presses the upper surface of the terrace 7a, which faces the middle end side of the bonded region of the terrace 7a, so that the extension end side of the bonded region of the terrace 7a is exposed to the pusher 130, and the extension end side of the bonded region of the terrace 7a, which is exposed to the outside of the pressing portion 122, is folded by the operation of the pusher 130.

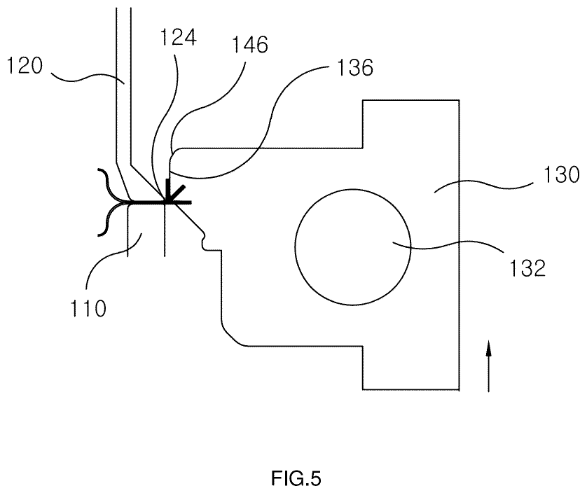

Further, an edge portion 124 is formed on a lower portion of one side surface of the upper prop 120, which faces the pusher 130. That is, the edge portion 124 is formed at an edge at which the pressing portion 122 and one side surface of the upper prop 120 are connected. As illustrated in FIG. 5, the edge portion 124 allows the terrace 7a to be folded upward by 90 degrees by the operation of the pusher 130.

In addition, a seat portion 126 is formed on one side surface of the upper prop 120 that faces the pusher 130, and the seat portion 126 allows the extension end side of the bonded region, which is folded upward at 90 degrees, to be further folded by 45 degrees by the operation of the pusher 130, that is, the extension end side of the bonded region of the terrace 7a is folded by 135 degrees by the operation of the pusher 130. The seat portion 126 is formed to be inclined upward by 135 degrees from the edge portion 124 toward a main chamber M with respect to the flat pressing portion 122.

When the lower prop 110 supports the lower surface of the terrace 7a that faces the middle end side of the bonded region of the terrace 7a, the upper prop 120 is lowered to come into contact with the upper surface of the terrace 7a, which faces the middle end side of the bonded region of the terrace 7a, and to press the terrace 7a toward the lower prop 110. When the extension end side of the bonded region of the terrace 7a is folded by 135 degrees by the pusher 130, the upper prop 120 is raised. To this end, the upper prop 120 is installed to be operable upward or downward.

In addition, the upper prop 120 is installed to be horizontally movable leftward or rightward so that when the extension end side of the bonded region of the terrace 7a is folded by 135 degrees by the pusher 130, the upper prop 120 may be withdrawn from the folded extension end side of the bonded region of the terrace 7a and raised.

The pusher 130 displaces the extension end side of the bonded region of the terrace 7a in a stepwise manner while coming into surface contact with the extension end side of the bonded region of the terrace 7a exposed to the outside of the lower prop 110 and the upper prop 120, such that the extension end side of the bonded region of the terrace 7a is folded by 180 degrees.

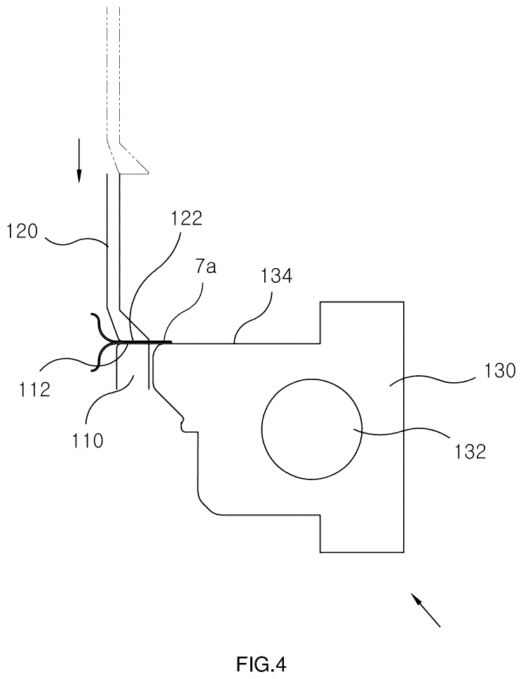

The pusher 130 is installed to face the lower prop 110 and the upper prop 120. As illustrated in FIGS. 4 to 10, the pusher 130 is formed to have a length corresponding to a length of the terrace 7a so that the pusher 130 may come into surface contact with the terrace 7a that faces the extension end side of the bonded region exposed to the outside of the lower prop 110 and the upper prop 120.

Further, the pusher 130 is installed to be movable upward or downward, horizontally movable leftward or rightward, and movable inclinedly so that the pusher 130 may displace the extension end side of the bonded region of the terrace 7a in a stepwise manner.

In addition, a typical heater 132 is embedded in the pusher 130. When the heater 132 heats the pusher 130, heat of the pusher 130 is transferred to the extension end side of the bonded region of the terrace 7a. The heat of the heater 132, which is transferred through the pusher 130 as described above, allows the extension end side of the bonded region of the terrace 7a to be easily folded and prevents damage to a bonding layer of a folding line portion formed when the extension end side of the bonded region of the terrace 7a is folded by 135 degrees.

Meanwhile, as illustrated in FIG. 4, the pusher 130 includes a flat upper surface 134 configured to come into surface contact with the lower surface of the terrace 7a that faces the extension end side of the bonded region exposed to the outside of the lower prop 110 and the upper prop 120.

In addition, the pusher 130 further includes a first forming portion 136, a second forming portion 138, and a third forming portion 144 that displace and fold the extension end side of the bonded region of the terrace 7a in a stepwise manner while coming into surface contact with the extension end side of the bonded region of the terrace 7a exposed to the outside of the lower prop 110 and the upper prop 120.

The first forming portion 136 is formed by combining the upper surface 134 of the pusher 130 and one side surface of the pusher 130 that faces the lower prop 110 and the upper prop 120. The first forming portion 136 is formed vertically along one side surface of the pusher 130.

When the lower surface of the terrace 7a, which faces the extension end side of the bonded region, comes into contact with the upper surface 134 of the pusher 130, the first forming portion 136, which is formed as described above, is raised along the pusher 130 and allows the extension end side of the bonded region of the terrace 7a to be folded upward by 90 degrees based on the edge portion 124 of the upper prop 120.

The second forming portion 138 is formed to be inclined downward at 45 degrees between the lower surface and the other side surface of the pusher 130 from an extension end of the first forming portion 136 with respect to the first forming portion 136.

When the first forming portion 136 folds the extension end side of the bonded region of the terrace 7a upward by 90 degrees, the second forming portion 138, which is formed as described above, moves inclinedly toward the seat portion 126 of the upper prop 120 along the pusher 130 and attaches the extension end side of the bonded region of the terrace 7a, which is folded at 90 degrees, tightly to the seat portion 126 so that the extension end side of the bonded region of the terrace 7a is folded by 135 degrees.

In this case, a groove 140 is formed at an extension end of the second forming portion 138 and provided as a concave curved surface that surrounds the folding line portion of the bonded region of the terrace 7a formed when the extension end side of the bonded region of the terrace 7a is folded by 135 degrees. A vertical avoidance portion 142 is formed between the groove 140 and the lower surface of the pusher 130.

In this case, the groove 140 may allow the heat of the heater to be transferred to the folding line portion of the bonded region of the terrace 7a to melt polymer without damaging the bonding layer. When the bonding layer is damaged, the groove 140 may allow the molten polymer to flow toward the bonding layer.

Further, the third forming portion 144 is formed on the flat lower surface of the pusher 130. When the upper prop 120 is raised after the extension end side of the bonded region of the terrace 7a is folded by 135 degrees, the third forming portion 144, which is formed as described above, is moved and lowered toward the main chamber M along the pusher 130 and presses the extension end side of the bonded region of the terrace 7a, which is folded at 135 degrees, toward the bonded region of the terrace 7a supported by the lower prop 110 so that the extension end side of the bonded region of the terrace 7a is folded by 180 degrees.

Meanwhile, the upper surface 134 and the first forming portion 136 of the pusher 130 are connected smoothly without a sharp corner by means of a first inclined portion 146 formed as an inclined surface. Likewise, the avoidance portion 142 and the third forming portion 144 of the pusher 130 are connected smoothly without a sharp corner by means of a second inclined portion 148 formed as an inclined surface.

When the first forming portion 136 for folding the extension end side of the bonded region of the terrace 7a by 90 degrees is raised, the first inclined portion 146, which is formed as described above, maintains the state in which the extension end side of the bonded region of the terrace 7a is in surface contact with the pusher 130. Likewise, when the third forming portion 144 for folding, by 180 degrees, the extension end side of the bonded region of the terrace 7a, which is folded at 135 degrees, is lowered, the second inclined portion 148 maintains the state in which the extension end side of the bonded region of the terrace 7a is in surface contact with the pusher 130.

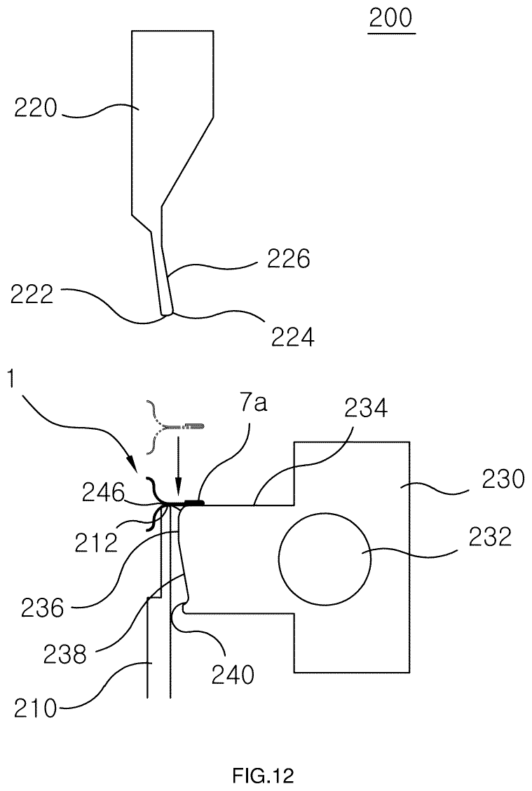

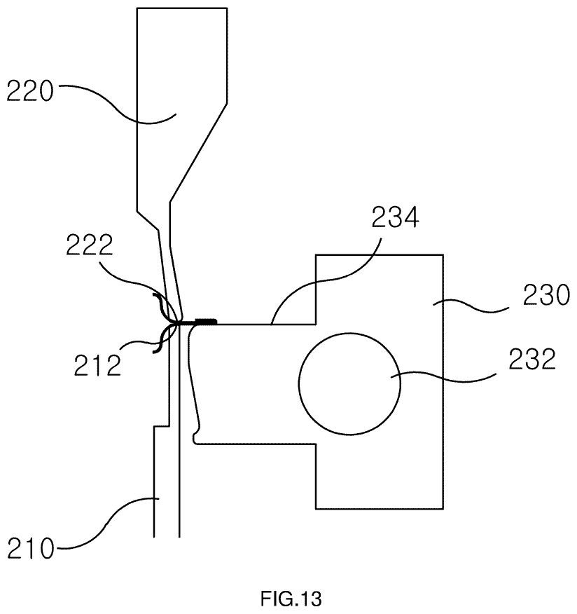

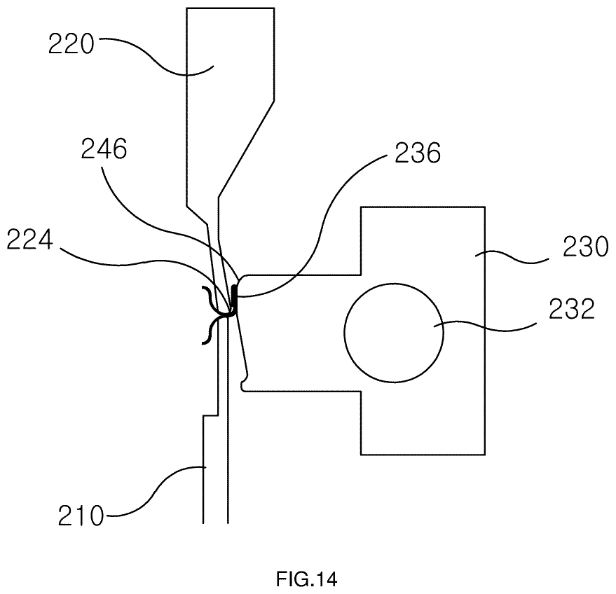

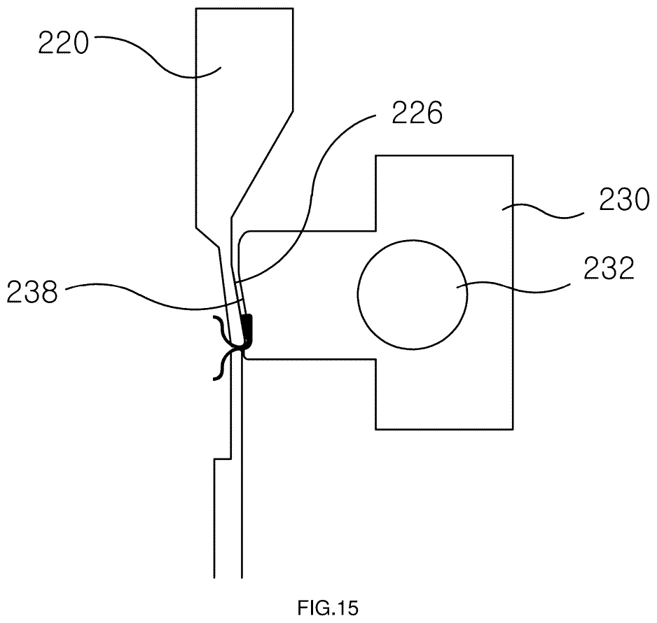

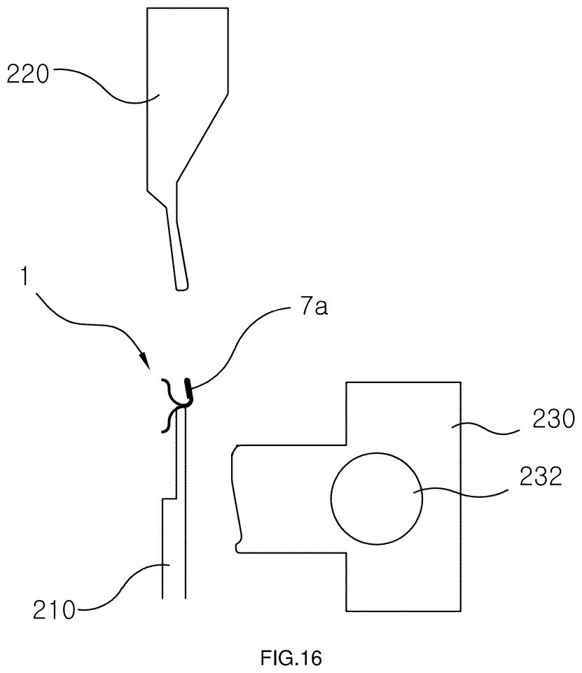

Among the accompanying drawings, FIGS. 12 to 16 are views schematically illustrating another embodiment of a pouch folding device for a secondary battery according to the present disclosure.

With reference to FIGS. 12 to 16, a pouch folding device 200 for a secondary battery according to the present disclosure includes a lower prop 210, an upper prop 220, and a pusher 230.

The lower prop 210 supports a lower surface of a terrace 7a of a pouch-type secondary battery 1 loaded onto and guided by a cell transfer shuttle (not illustrated) during a preceding process, i.e., a process of folding an extension end side of a bonded region of the terrace 7a by 180 degrees.

The lower prop 210 has a length corresponding to a length of the terrace 7a. A flat support portion 212 is formed on an upper surface of the lower prop 210, and the lower surface of the terrace 7a is placed on the flat support portion 212.

The support portion 212 of the lower prop 210 supports the lower surface of the terrace 7a, which faces a start end side of the bonded region of the terrace 7a, so that the extension end side of the bonded region of the terrace 7a, which is folded at 180 degrees, is exposed to the pusher 230. The start end side of the bonded region of the terrace 7a, which is supported by the support portion 212, is folded by an operation of the pusher 230.

When the pouch-type secondary battery 1 is loaded onto and guided by the cell transfer shuttle, the lower surface of the terrace 7a is supported on the support portion 212 of the lower prop 210 by a downward operation of the cell transfer shuttle.

The upper prop 220, together with the lower prop 210, grips the terrace 7a by pressing an upper surface of the terrace 7a of the pouch-type secondary battery 1, which is placed on the lower prop 210, toward the lower prop 210.

The upper prop 220 has a length corresponding to the length of the terrace 7a. A flat pressing portion 222 is formed on a lower surface of the upper prop 220 and comes into contact with the upper surface of the terrace 7a to press the upper surface of the terrace 7a toward the lower prop 210.

The pressing portion 222 of the upper prop 220 presses the upper surface of the terrace 7a, which faces the start end side of the bonded region of the terrace 7a, so that the extension end side of the bonded region of the terrace 7 a, which is folded at 180 degrees, is exposed to the pusher 230. The start end side of the bonded region of the terrace 7a, which is supported by the support portion 212, is folded by an operation of the pusher 230.

Further, an edge portion 224 is formed on a lower portion of one side surface of the upper prop 220, which faces the pusher 230. That is, the edge portion 224 is formed at an edge at which the pressing portion 222 and one side surface of the upper prop 220 are connected. As illustrated in FIG. 5, the edge portion 224 allows the start end side of the bonded region of the terrace 7a to be folded upward by 90 degrees by the operation of the pusher 230.

In addition, a seat portion 226 is formed on one side surface of the upper prop 220 that faces the pusher 230, and the seat portion 226 allows the terrace 7a to be folded at 90 degrees or more by the operation of the pusher 230. The seat portion 226 extends to be inclined upward with respect to the flat pressing portion 222 from the edge portion 224 toward a main chamber M. In this case, an inclination angle of the seat portion 226 is not specially limited.

When the lower prop 210 supports the lower surface of the terrace 7a that faces the start end side of the bonded region of the terrace 7a, the upper prop 220 is lowered to come into contact with the upper surface of the terrace 7a, which faces the start end side of the bonded region of the terrace 7a, and to press the terrace 7a toward the lower prop 210. When the start end side of the bonded region of the terrace 7a is folded by 90 degrees or more by the pusher 230, the upper prop 220 is raised. To this end, the upper prop 220 is installed to be operable upward or downward.

The pusher 230 displaces the start end side of the bonded region of the terrace 7a in a stepwise manner while coming into surface contact with the extension end side of the bonded region of the terrace 7a folded at 180 degrees and exposed to the outside of the lower prop 210 and the upper prop 220, such that the start end side of the bonded region of the terrace 7a is folded at 90 degrees or more, and the terrace 7a has a shape folded at 270 degrees.

The pusher 230 is installed to face the lower prop 210 and the upper prop 220. The pusher 230 is formed to have a length corresponding to a length of the terrace 7a so that the pusher 230 may come into surface contact with the extension end side of the bonded region of the terrace 7a exposed to the outside of the lower prop 210 and the upper prop 220.

Further, the pusher 230 is installed to be movable upward or downward, horizontally movable leftward or rightward, and movable inclinedly so that the pusher 230 may displace the start end side of the bonded region of the terrace 7a in a stepwise manner.

In addition, a typical heater 232 is embedded in the pusher 230. When the heater 232 heats the pusher 230, heat of the pusher 230 is transferred to the extension end side of the bonded region of the terrace 7a. The heat of the heater 232, which is transferred through the pusher 230 as described above, allows the extension end side of the bonded region of the terrace 7a to be easily folded and prevents damage to a bonding layer of a folding line portion formed when the start end side of the bonded region of the terrace 7a is folded by 90 degrees or more.

Meanwhile, as illustrated in FIGS. 3 and 4, the pusher 230 includes a flat upper surface 234 configured to come into surface contact with the lower surface of the terrace 7a that faces the extension end side of the bonded region of the terrace 7a folded at 180 degrees and exposed to the outside of the lower prop 210 and the upper prop 220.

In addition, the pusher 230 further includes a fourth forming portion 236 and a fifth forming portion 238 that displace and fold the start end side of the bonded region of the terrace 7a in a stepwise manner while coming into surface contact with the extension end side of the bonded region of the terrace 7a folded at 180 degrees and exposed to the outside of the lower prop 210 and the upper prop 220.

The fourth forming portion 236 is formed by combining the upper surface 234 of the pusher 230 and one side surface of the pusher 230 that faces the lower prop 210 and the upper prop 220. The fourth forming portion 236 is formed vertically along one side surface of the pusher 230.

When the lower surface of the extension end side of the bonded region of the terrace 7a, which is folded at 180 degrees, comes into contact with the upper surface 234 of the pusher 230, the fourth forming portion 236, which is formed as described above, is raised along the pusher 230 and pushes upward the extension end side of the bonded region of the terrace 7a, which is folded at 180 degrees, with respect to the edge portion 224 so that the start end side of the bonded region of the terrace 7a is folded upward by 90 degrees.

The fifth forming portion 238 is formed to be inclined downward between the lower surface and the other side surface of the pusher 230 from an extension end of the fifth forming portion 236 with respect to the fourth forming portion 236. In this case, the fifth forming portion 238 is formed to have an inclination angle equal to an inclination angle of the seat portion 226.

When the fourth forming portion 236 pushes upward the extension end side of the bonded region of the terrace 7a folded at 180 degrees and folds the start end side of the bonded region of the terrace 7a by 90 degrees, the fifth forming portion 238, which is formed as described above, moves inclinedly along the pusher 230 toward the seat portion 226 of the upper prop 220 and attaches the extension end side of the bonded region of the terrace 7a, which is folded at 180 degrees, tightly to the seat portion 226 so that the start end side of the bonded region of the terrace 7a is folded by 90 degrees or more.

In this case, a groove 240 is formed at an extension end of the fifth forming portion 238 and provided as a concave curved surface that surrounds a folding line portion of the start end side of the bonded region of the terrace 7a that is formed when the start end side of the bonded region of the terrace 7a is folded by 90 degrees or more.

In this case, the groove 240 may allow the heat of the heater 232 to be transferred to the folding line portion of the bonded region of the terrace 7a to melt polymer without damaging the bonding layer. When the bonding layer is damaged, the groove 240 may allow the molten polymer to flow toward the bonding layer.

Meanwhile, the upper surface 234 and the fourth forming portion 236 of the pusher 230 are softly connected by means of an inclined portion 246 formed as an inclined surface.

The inclined portion 246, which is formed as described above, maintains a state in which the extension end side of the bonded region of the terrace 7a, which is folded at 180 degrees, is in surface contact with the pusher 230 when the fourth forming portion 236 is raised.

What is claimed is:

1. A pouch folding device for a secondary battery, the pouch folding device comprising:
a lower prop configured to support a lower surface of a terrace of a pouch-type secondary battery;
an upper prop configured to grip the terrace together with the lower prop by pressing an upper surface of the terrace, which is placed on the lower prop, toward the lower prop; and
a pusher configured to fold the terrace based on a folding line portion by displacing the terrace in a stepwise manner by applying heat and force while coming into contact with the terrace exposed to the outside of the lower prop and the upper prop.

2. The pouch folding device of claim 1, wherein a heater is embedded in the pusher, the pusher has a concave groove that surrounds the folding line portion, and the groove applies heat and force to the folding line portion.

3. The pouch folding device of claim 2, wherein the upper prop comprises:
a flat pressing portion configured to press the upper surface of the terrace toward the lower prop;
an edge portion formed at an edge at which one side surface of the upper prop, which faces the pusher, and the pressing portion are connected, the edge portion being configured to form the folding line portion so that the terrace is folded upward by an operation of the pusher; and
a seat portion formed on one side surface of the upper prop, which faces the pusher, and inclined upward from the edge portion with respect to the pressing portion in a direction away from the pusher, the seat portion being configured to allow the terrace, which is folded upward, to be further folded by the operation of the pusher.

4. The pouch folding device of claim 2, wherein the pusher comprises:
a flat upper surface configured to come into surface contact with the lower surface of the terrace exposed to the outside of the lower prop and the upper prop;
a first forming portion configured to fold the terrace upward based on the edge portion while being raised;
a second forming portion configured to attach the terrace, which is folded by the first forming portion, tightly to the seat portion while being moved inclinedly toward the seat portion; and
a third forming portion configured to fold the terrace by 180 degrees by pressing the terrace toward the lower prop while being moved upward from the terrace, which is folded by the second forming portion, and raised.

5. The pouch folding device of claim 4, wherein the first forming portion is one side surface facing the lower prop and the upper prop, the first forming portion is connected to the upper surface and formed perpendicularly to the upper surface, the second forming portion is formed to be inclined downward from a distal end of the first forming portion in a direction away from the lower prop and the upper prop, the groove is provided at a distal end of the second forming portion, and the third forming portion has a flat lower surface positioned below the groove.

6. The pouch folding device of claim 5, wherein the upper surface and the first forming portion are connected smoothly without a sharp corner by means of a first inclined portion formed as an inclined surface.

7. The pouch folding device of claim 5, wherein the third forming portion is connected to a distal end of the groove and has an avoidance portion facing the lower prop and the upper prop, and the avoidance portion and the lower surface are connected smoothly without a sharp corner by means of a second inclined portion formed as an inclined surface.

8. The pouch folding device of claim 7, wherein the avoidance portion is formed to be retracted from the distal end of the groove in the direction away from the lower prop and the upper prop.

9. The pouch folding device of claim 3, wherein the pusher comprises:
a flat upper surface configured to come into surface contact with the lower surface of the terrace exposed to the outside of the lower prop and the upper prop;
a fourth forming portion configured to fold the terrace upward based on the edge portion while being raised; and
a fifth forming portion configured to fold the folded terrace by 90 degrees or more by attaching the terrace, which is folded by the fourth forming portion, tightly to the seat portion while being moved inclinedly toward the seat portion.

10. The pouch folding device of claim 9, wherein the fourth forming portion is one side surface facing the lower prop and the upper prop, the fourth forming portion is connected to the upper surface and formed perpendicularly to the upper surface, the fifth forming portion is formed to be inclined downward from a distal end of the fourth forming portion in a direction away from the lower prop and the upper prop, and the groove is positioned at a distal end of the fifth forming portion.

11. The pouch folding device of claim 10, wherein the upper surface and the fourth forming portion are connected smoothly without a sharp corner by means of an inclined portion formed as an inclined surface.

12. The pouch folding device of claim 9, wherein the edge portion further protrudes toward the terrace than the lower prop.

13. The pouch folding device of claim 1, wherein the terrace has a bonded region and a non-bonded region, and
wherein the folding line portion, which is positioned in the non-bonded region of the terrace.
